(19) United States
(12) Patent Application Publication
(10) Pub. No.: US 2009/0256113 A1
(43) Pub. Date: Oct. 15, 2009

(54) Method for the Production of Bleaching Catalyst Granules

(76) Inventors: Georg Borchers, Bad Nauheim (DE); Andreas Schottstedt, Hofheim (DE); Michael Wessling, Kandern (DE)

Correspondence Address: CLARIANT CORPORATION;INTELLECTUAL PROPERTY DEPARTMENT, 4000 MONROE ROAD, CHARLOTTE, NC, 28205, US

(21) Appl. No.: 11/989,444

(22) PCT Filed: Jul. 25, 2006
(86) PCT No.: PCT/EP2006/007293

§ 371 Date: Apr. 27, 2009

(30) Foreign Application Priority Data
Jul. 28, 2005 (DE) 10 2005 035 916.7

(51) Int. Cl. C09K 3/00

(52) U.S. Cl. 252/186.25

(57) ABSTRACT

The invention relates to a method for the production of bleaching catalyst granules, containing a bleaching catalyst, an acidic polymer, a support material and optionally further adjuncts, characterized in that a fluid bed is formed from the support material in a fluidized bed apparatus, an aqueous solution or dispersion is added to the fluid bed, containing the bleaching catalyst, the acidic polymer, and optionally the further adjuncts which is then granulated and dried. The method is particularly suitable for bleaching catalysts of formula (1), where R, R¹, R², R³ and X have the meanings given in the description.

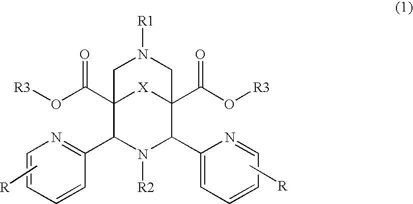

The invention provides a process for producing granules comprising a bleach catalyst and an acidic component, and optionally further additives, wherein an aqueous solution or suspension comprising a bleach catalyst and an acidic component is granulated in a pneumatically generated fluidized bed and simultaneously dried. The fluidized bed granules are notable for very good storage stability, uniform morphology and high attrition resistance.

Even at low use concentrations, the use of bleach catalysts in washing and cleaning compositions enables very efficient stain removal even at low wash temperatures.

Compounds of the formula (1)

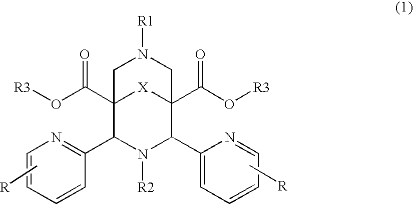

or organometallic complexes which contain these compounds of the formula (1) as a ligand are very powerful bleach catalysts. In the formula (1), R is hydrogen, fluorine, chlorine, bromine, hydroxyl, C₁-C₄ alkoxy, —NH—CO—H, —NH—CO—C₁-C₄-alkyl, —NH₂, —NH—C₁-C₄-alkyl, R¹ and R² are each independently C₁-C₄ alkyl, C₆-C₁₀ aryl or a group which contains a heteroatom, preferably (CH₂)_{z}-2-pyridyl where z is from 1 to 5; R³ is hydrogen or C₁-C₄ alkyl and X is C═O or —[C(R)₂]_{y}— where y is from 0 to 3 and R is hydrogen, hydroxyl, C₁-C₄ alkoxy or C₁-C₄ alkyl.

The organometallic complexes are illustrated by formula 2:

[MₐLₖXₙ]Yₘ (2)

where M is Mn(II), Mn(III), Mn(IV), Mn(V), Cu(I), Cu(II), Cu(II), Fe(II), Fe(III), Fe(IV), Fe(V), Co(I), Co(II), Co(III), Ti(II), Ti(III), Ti(IV), V(II), V(III), V(IV), V(V), Mo(II), Mo(III), Mo(IV), Mo(V), Mo(VI) and W(IV), W(V) and W(VI), preferably Fe(II), Fe(II), Fe(IV), Fe(V),
L is a ligand of the formula (1), preferably dimethyl 2,4-di(2-pyridyl)-3-methyl-7-(pyridin-1-ylmethyl)-3,7-diazabicyclo[3.3.1]nonan-9-one-1,5-dicarboxylate or the protonated form thereof,
X is a singly, doubly or triply charged anion or an uncharged molecule which can coordinate to M,
Y is a noncoordinating counterion
and
a is an integer from 1 to 10,
k is an integer from 1 to 10,
n is an integer from 0 to 10,
m is an integer from 0 to 20.

The preparation of the ligands of the formula (I) and of the metal complexes of the formula (2) is described in WO 02/48301.

The use of these complexes in the form of granules in bleach formulations is described in WO 02/066592. In this document, the granules are produced by mixing the bleach catalyst in the form of a dry powder with sodium sulfate and an aqueous solution of a binder, for example an acidic polymer such as Sokalan® CP45 in a high-speed mixer and then drying the moist granules in a fluidized bed.

When the catalyst, in contrast, is to be formulated from an aqueous solution or suspension, this can give rise to a series of process technology difficulties.

Considering the water budget of the system, there is the risk that, when the catalyst solution is introduced, too great an amount of water gets into the mixture and leads to lump formation as a result of overmoistening. In particular, this is expected when carrier materials with a low liquid loading capacity are to be used, such as the particularly preferred sodium sulfate mentioned. More suitable carrier materials may, for example, be silicas, bentonites, zeolites or the like, but usually have the disadvantage of water insolubility or other incompatibilities (e.g. alkaline pH). Equally, for these carrier substances too, there is the risk that the loading limit is exceeded and lump formation and increased coarse material formation occur.

Further difficulties can arise in the selection of the suitable binder. At first, it appears in many cases to be advantageous to adjust granules to an acidic pH in order thus to reduce or to prevent the alkaline hydrolysis of the active component in the washing powder formulation and thus to significantly improve the chemical storage stability. Particular preference is therefore given to binders which, as well as the binder function, also enable the setting of an acidic pH. The usual binders in this case are polycarboxylates and copolymers thereof, for example the aforementioned Sokalan CP45. A disadvantage is that these products with the desired pH function are frequently available only as an aqueous solution. This fact has the consequence that the above-described difficulties in controlling the water budget in the mixing process are aggravated, since additional water contents are introduced into the system via the binder solution.

A further problem can arise when the catalyst solution or suspension is to be metered in with the binder solution as a liquid mixture. Combined metered addition as a mixture is desirable here, since the process technology complexity is firstly reduced and a uniform granule composition with optimal acid protection function is secondly achieved. However, as is also known from other systems (for example mixture of some Sokalan binders with cationic surfactants), massive incompatibilities can occur between catalyst solution and binder solution. This can be manifested by direct chemical reaction (for example noticeable by discolorations), but also by precipitates, conglutination, etc., which prevent controllability of the granulation process.

Considering, finally, the requirements on the finished granule which comprises the bleach catalyst, further aspects should be taken into account in determining granule formulation. In addition to the requirements on the chemical properties (for example performance, storage stability), requirements on the physical properties also have to be met. In this context, problem-free handling is of great significance, i.e. the granule should, for example, have a low caking tendency which is frequently caused by moisture absorption, or have a high attrition stability. In the optimization of the granule composition, however, the performance must not be impaired, which is frequently found to be inconsistent with attrition stability and good dissolution.

It was therefore an object of the present invention to provide a suitable process for an improved granule formulation. On the one hand, the process technology difficulties outlined should be avoided and a stable problem-free process should be enabled. On the other hand, a formulation should be provided which meets the described requirements on the granule.

It has been found that, surprisingly, this object is achieved by a granulation process in which an aqueous mixture of bleach catalyst, acidic components and optional further additives is sprayed onto a suitable carrier material in a fluidized bed, and granulated and simultaneously dried.

The invention thus provides a process for producing bleach activator granules comprising a bleach catalyst, an acidic polymer, a carrier material and optionally further additives. This process comprises forming a fluidized bed from the carrier material in a fluidized bed apparatus, metering an aqueous solution or suspension which comprises the bleach catalyst, the acidic polymer and any further assistants into this fluidized bed, granulating and drying.

The granules thus obtained can subsequently also be provided with a coating by processes known per se.

Useful bleach catalysts in accordance with the present invention are preferably the compounds of the formula (1) and the metal complexes of the above formula (2) which contain the compounds of the formula (1) as ligands. Preference is given to the compound dimethyl 2,4-di(pyridyl)-3-methyl-7-(pyridin-2-ylmethyl)-3,7-diazabicyclo[3.3.1]nonan-9-one-1,5-di-carboxylate.

The acidic polymers used in the process according to the invention are preferably water-soluble acidic polymers. “Water-soluble” means that they are soluble to a degree of more than 5 g/l at 20° C. 1% solutions of these polymers have a pH of <7, preferably <5.5. The polymers used typically have a molecular weight in the range of from 1000 to 280 000, preferably from 1500 to 150 000.

Preference is given to polymeric polycarboxylates. Polymeric polycarboxylates may be homo- or copolymers of acrylic acid, methacrylic acid or maleic acid, and also copolymers of these acids with vinyl ethers such as vinyl methyl ether or vinyl ethyl ether, vinyl esters such as vinyl acetate or vinyl propionate, acrylamide, methacrylamide, and also ethylene, propylene or styrene, and the water-soluble salts of these polymers. Particularly suitable polymers are those of acrylic acid, modified polyacrylates, copolymers of acrylic acid and maleic acid, and copolymers of maleic acid and olefins. Such polymers are available commercially, for example, under the name Sokalan®. Preference is given to the Sokalan CP 12S and Sokalan CP 13S types.

The carrier materials used in the process according to the invention may be of inorganic and/or organic nature.

Suitable inorganic carriers are finely crystalline synthetic zeolites, for example zeolite A, X and/or P, or mixtures of these zeolites, and equally amorphous alkali metal silicates or crystalline sheet silicates, sodium carbonate, sodium bicarbonate, sodium sulfate, and also trisodium citrate or mixtures of these carrier substances. Equally suitable are alkali metal phosphates which may be present in the form of their alkaline, neutral or acidic sodium or potassium salts. Examples thereof are trisodium phosphate, tetrasodium diphosphate, disodium dihydrogenphosphate, pentasodium triphosphate, so-called sodium hexametaphosphate, oligomeric trisodium phosphate having degrees of oligomerization of from 5 to 1000, especially from 5, to 50, and mixtures of sodium and potassium salts. A preferred carrier material is sodium sulfate.

The bleach catalyst granules produced by the process according to the invention may, based on the finished granule, contain from 30% by weight to 99% by weight, preferably from 50% by weight to 90% by weight, more preferably from 80% by weight to 88% by weight, of carrier material.

The bleach catalyst granules produced in accordance with the invention may comprise additional binders, acidic additives or granulating assistants as further additives.

Useful binders include cellulose and starch and ethers or esters thereof, for example carboxymethylcellulose (CMC), methylcellulose (MC) or hydroxyethylcellulose (HEC) and the corresponding starch derivatives, but also film-forming polymers, for example polyacrylic acids or salts thereof.

The amount of binder, based on the finished granule, may be from 0 to 45% by weight, preferably from 1 to 30% by weight.

A suitable additional acidic additive is sulfuric acid, sodium hydrogensulfate, phosphoric acid, sodium hydrogenphosphate, phosphonic acids and salts thereof, carboxylic acids or salts thereof, such as citric acid in anhydrous or hydrated form, glycolic acid, succinic acid, succinic anhydride, glutaric acid, glutaric anhydride, adipic acid, adipic anhydride, maleic acid, maleic anhydride, tartaric acid, lactic acid, mandelic acid, pyruvic acid, salicylic acid, ascorbic acid, fumaric acid, retinoic acid, benzoic acid, kojic acid, fruit acid, malic acid, gluconic acid, sulfonic acids and amidosulfonic acid.

The amount of acidic additive in addition to the above-defined acidic polymers used in accordance with the invention, especially in addition to the Sokalan types, is such that the proportion of the acidic additive in the finished granule is from about 0 to 20% by weight, preferably from 1 to 10% by weight, especially from 2 to 6% by weight.

The granulating assistants used may be anionic or nonionic surfactants or polyalkylene glycols. Preferred anionic surfactants are alkali metal salts, ammonium salts, amine salts and salts of amino alcohols of the following compounds: alkyl sulfates, alkyl ether sulfates, alkylamide sulfates, and alkylamide ether sulfates, alkylaryl polyether sulfates, monoglyceride sulfates, alkylsulfonates, alkylamide sulfonates, alkylarylsulfonates, α-olefinsulfonates, alkyl sulfosuccinates, alkyl ether sulfosuccinates, alkylamide sulfosuccinates, alkyl sulfoacetates, alkylpolyglyceryl carboxylates, alkyl phosphates, alkyl ether phosphates, alkyl sarcosinates, alkyl polypeptidates, alkyl amidopolypeptidates, alkyl isothionates, alkyl taurates, alkyl polyglycol ether carboxylic acids or fatty acids such as oleic acid, ricinoleic acid, palmitic acid, copra oil acid salt or hydrogenated copra oil acid salts. The alkyl radical of all of these compounds contains normally from 8 to 32, preferably from 8 to 22 carbon atoms. Particular preference is given to linear straight-chain alkylbenzenesulfonates, especially having a C₈-C₂₀-, more preferably having a C₁₁₋₁₃-alkyl group, or arylsulfonate, for example cumenesulfonate.

The nonionic surfactants used may be polyethoxylated, polypropoxylated or polyglycerylated ethers of fatty alcohols, polyethoxylated, polypropoxylated and polyglycerylated fatty acid esters, polyethoxylated esters of fatty acids and of sorbitol, polyethoxylated or polyglycerylated fatty amides.

The process according to the invention is specifically performed as follows. An aqueous solution or suspension of the bleach catalyst containing from about 5% by weight to 50% by weight, preferably from 10% by weight to 40% by weight, more preferably from 20 to 35% by weight of bleach catalyst, based on the aqueous solution or suspension, is mixed at from 10° C. to 40° C., preferably at room temperature, with an aqueous solution containing from 5 to 80% by weight, preferably from 10 to 60% by weight, more preferably from 20 to 55% by weight, of the acidic polymer, for example Sokalan CP 13.

The mixing ratio of bleach catalyst to acidic polymer is preferably in the range from 1:1 to 1:3, preferably 1.5:2.5, more preferably 1.6:2 parts by weight.

The mixture is then sprayed onto the support material in a fluidized bed apparatus.

To produce the bleach catalyst granules, fluidized bed apparatus is used, which may preferably be of cylindrical or conical or else rectangular structure.

In a preferred embodiment, the fluidized bed apparatus is round and has base plates with dimensions of at least 0.4 m in diameter. Especially preferred is fluidized bed apparatus which has a base plate with a diameter between 0.4 m and 3 m, for example 1.2 m or 2.5 m. In a further preferred embodiment, the fluidized bed apparatus may have a rectangular shape, in which case the inflow surface is from 0.2 to 10 m², for example 1.25 m² or 7.5 m². The base plate used may be a perforated base plate or a Conidur plate, a wire mesh or a combination base composed of a perforated plate with a mesh.

The granulation process according to the invention may be performed either batchwise or continuously. In the case of batchwise operation, the carrier material is first initially charged in the apparatus and then sprayed with the granulation fluid which comprises the bleach catalyst, the acidic polymer and optionally the further additives. The process parameters are adjusted such that granulation proceeds to achieve the desired particle sizes. On attainment of the required concentrations of the bleach catalyst, the spray application is ended. In the case of a continuous process, the solid support material and the granulation fluid are metered simultaneously into the apparatus. In this case, it should be ensured that the two product streams are metered in in the correct ratio relative to one another in order to achieve the required granule composition.

An additional solid feed, for example of dustlike fine fractions of the finished granules or of pulverulent formulation components, may be advantageous.

A further process variant consists in optionally heating the aqueous mixture of bleach catalyst, acidic polymer and any further additives, prepared by mixing at room temperature, to a temperature of from 25° C. to 85° C., pumping it to the nozzle by means of a suitable pump and spraying it into the fluidized bed from the bottom. The air entry temperature is between 90 and 97° C. The fluidizing air cools as a result of heat losses and as a result of the heat of evaporation of the solvent. This adjusts the temperature of the coating material in the fluidized bed to from 50 to 70° C. The air exit temperature is between 55° C. and 65° C.

In the fluidized bed granulation, the water content of the products can be set within wide limits. In the process according to the invention, the granulation in the fluidized bed is accompanied by simultaneous drying. In a preferred embodiment of the invention, the process is conducted such that the water content of the finished granules is <2% by weight.

In the case of a continuous process, the finished granule is discharged from the fluidized bed advantageously via a size classification of the granule. This classification can be effected by means of a sifting discharge which is regulated such that only particles from a particular particle size are discharged from the fluidized bed and smaller particles are retained in the fluidized bed. The particles discharged by the gas stream above the fluidized bed are separated out (for example by dust filters). The dust removed is conducted back into the fluidized bed in the region of the spray nozzle, where rewetting takes place.

Granules preferred in accordance with the invention have a d₅₀ value between 0.2 and 0.9 mm. In a particularly preferred embodiment, the particle fraction which is larger than 1.0 mm is recycled. This coarse fraction can, after grinding, be added as solid component to the fluidized bed.

The process according to the invention enables simultaneous granulation and drying, such that the composition of the granulation fluid to be processed can be varied within very wide limits without meeting process-limiting boundaries. This flexibility enables problem-free adjustment of the additive content needed to the granule requirements.

The granules obtained in accordance with the invention are suitable directly for use in washing and cleaning compositions. They are notable for a good chemical and physical storage stability, high attrition stability and nevertheless good solubility in use.

In addition, they may, however, be provided with a coating by processes known per se. To this end, the granule, in an additional step, is enveloped with a film-forming substance, which can considerably influence the product properties. Suitable coating media are all film-forming substances such as waxes, silicones, fatty acids, fatty alcohols, soaps, anionic surfactants, nonionic surfactants, cationic surfactants, anionic and cationic polymers, polyethylene glycols and polyalkylene glycols. Particular preference is given to polymeric polycarboxylates. Polymeric polycarboxylates may be homo- or copolymers of acrylic acid, methacrylic acid or maleic acid, and also copolymers of these acids with vinyl ethers such as vinyl methyl ether or vinyl ethyl ether, vinyl esters such as vinyl acetate or vinyl propionate, acrylamide, methacrylamide, and also ethylene, propylene or styrene, and also the water-soluble salts of these polymers. Particularly suitable polymers are those of acrylic acid, modified polyacrylates, copolymers of acrylic acid and maleic acid, and copolymers of maleic acid and olefins, especially Sokalan® types from BASF, more preferably Sokalan CP 13S.

Also useful in principle are C₈-C₃₁-fatty acids (e.g.: lauric acid, myristic acid, stearic acid), dicarboxylic acids, for example glutaric acid, adipic acid or anhydrides thereof; phosphonic acids, optionally phosphonic acids in a blend with other common coating media, especially fatty acids, for example stearic acid, C₈-C₃₁-fatty alcohols; polyalkenyl glycols (e.g. polyethylene glycols having a molar mass of from 1000 to 50 000 g/mol); nonionics (for example C₈-C₃₁-fatty alcohol polyalkoxylates having from 1 to 100 moles of EO); anionics (for example alkanesulfonates, alkylbenzenesulfonates, α-olefinsulfonates, alkyl sulfates, alkyl ether sulfates having C₈-C₃₁-hydrocarbon radicals); polymers (e.g. polyvinyl alcohols); waxes (e.g. montan waxes, paraffin waxes, ester waxes, polyolefin waxes); silicones.

In addition, further substances which do not soften or melt in this temperature range may be present in the coating substance in dissolved or suspended form, for example: polymers (e.g. homopolymers, copolymers or graft copolymers of unsaturated carboxylic acids and/or sulfonic acids and alkali metal salts thereof, cellulose ethers, starch, starch ethers, polyvinylpyrrolidone); organic substances (e.g. mono- or polybasic carboxylic acids, hydroxycarboxylic acids or ethercarboxylic acids having from 3 to 8 carbon atoms and salts thereof); dyes; inorganic substances (for example: silicates, carbonates, bicarbonates, sulfates, phosphates, phosphonates).

According to the desired properties of the coated bleach catalyst granule, the content of coating substance may be from 1 to 30% by weight, preferably from 5 to 15% by weight based on coated bleach catalyst granules.

To apply the coating substances, it is possible to utilize mixers (mechanically induced fluidized bed) and more preferably fluidized bed apparatus (pneumatically induced fluidized bed). Possible mixers are, for example, plowshare mixers (continuous and batchwise), ring layer mixers or else Schugi mixers. Both in the mixer process and in the fluidized bed process, the coating substance can be sprayed on via a one-substance or two-substance nozzle apparatus.

Use of these coating materials allows the storage stability and hygroscopicity, and also the compatibility with other washing composition constituents, especially strongly alkaline components, to be improved further, and the reaction kinetics can be influenced in a controlled manner in order in this way to prevent interactions between the bleach catalyst and other components actually before the wash process.

The granules produced in accordance with the invention are notable for very good storage stability in pulverulent washing, cleaning and disinfectant formulations. They are ideal for use in heavy-duty washing compositions, stain removal salts, machine dishwasher detergents and pulverulent all-purpose detergents.

### EXAMPLE 1

### Granulation with an Acidic Component

For laboratory experiments, a Glatt GPCG 1.1 batchwise laboratory fluidized bed with an inflow diameter of D=150 mm was used, and the spray nozzle sprayed into the fluidized bed from the bottom.

Sodium sulfate was initially charged batchwise in the fluidized bed apparatus as a fine free-flowing product and then warmed up by the fluidization air. On attainment of the start temperature, the liquid metering was started and liquid mixture comprising dimethyl 2,4-di(pyridyl)-3-methyl-7-(pyridin-2-ylmethyl-3,7-diazabicyclo(3.3.1)nonan-9-one-1,5-dicarboxylate as the bleach activator and an acid-modified (meth)acrylic acid copolymer (Sokalan CP 13S) as the acidic polymer were atomized into the moving fluidized bed by means of a two-substance nozzle. The amount of spray liquid conveyed with a peristaltic pump was determined gravimetrically by means of a balance. The feed air temperature was adjusted to approx. 95-97° C. With the optimal spray output established, a temperature in the fluidized bed of approx. 64-65° C. was established, and it was possible to keep this temperature level stable. After an experiment run time of approx. 64 min, the required amount of liquid had been metered in. After the cooling and subsequent drying of the granule, fractionation was effected by screening off the coarse fractions of >1000 μm and fine fractions of <200 μm. With these experimental conditions, a granule yield of approx. 90.4% was achieved for the target particle range. The bulk density of the granule was approx. 884 g/l; the attritus content was 12.9%. The end granule had the following composition:

| | |
|---|---|
| bleach catalyst (dry) | 6.01% |
| Sokalan CP 13S (dry) (acid component) | 10.01% |
| sodium sulfate | 83.48% |
| residual moisture content | 0.5% |

### EXAMPLE 2

### Granulation with an Acidic Component and Addition of a Further Additive

For laboratory experiments, a Glatt GPCG 1.1 batchwise laboratory fluidized bed with an inflow diameter of D=150 mm was used, and the spray nozzle sprayed into the fluidized bed from the bottom.

Sodium sulfate was initially charged batchwise in the fluidized bed apparatus as a fine free-flowing product and then warmed up by the fluidization air. On attainment of the start temperature, the liquid metering was started and the liquid mixture comprising the same bleach activator and the same acidic polymer as in example 1 and also maleic acid (additive) was atomized into the moving fluidized bed by means of a two-substance nozzle. The amount of spray liquid conveyed with a peristaltic pump was determined gravimetrically by means of a balance. The feed air temperature was adjusted to approx. 95-97° C. With the optimal spray output established, a temperature in the fluidized bed of approx. 65-70° C. was established, and it was possible to keep this temperature level stable. After an experiment run time of approx. 90 min, the required amount of liquid had been metered in. After the cooling and subsequent drying of the granule, fractionation was effected by screening off the coarse fractions of >1000 μm and fine fractions of <200 μm. With these experimental conditions, a granule yield of approx. 75.8% was achieved for the target particle range. The bulk density of the granule was approx. 972 g/l; the attritus content was 1.2%. The end granule had the following composition:

| | |
|---|---|
| bleach catalyst (dry) | 5.8% |
| Sokalan CP 13S (dry) (acid component) | 12.1% |
| maleic acid (additive) | 10.08 |
| sodium sulfate | 71.52% |
| residual moisture content | 0.5% |

1. A process for producing a bleach catalyst granule comprising a bleach catalyst, an acidic polymer, a carrier material and optionally further additives, said process comprising forming a fluidized bed from the carrier material in a fluidized bed apparatus, metering an aqueous solution or suspension which comprises the bleach catalyst, the acidic polymer and optionally any further additives into the fluidized bed, granulating and drying to provide the bleach catalyst granule.

2. The process as claimed in claim 1, further comprising coating the bleach catalyst granule with a coating layer.

3. The process as claimed in claim 1, wherein the bleach catalyst is a compound of the formula (1) 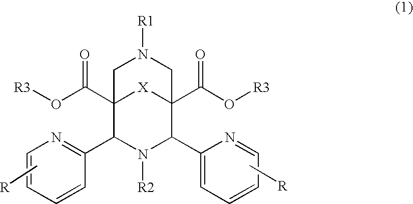
where R is hydrogen, fluorine, chlorine, bromine, hydroxyl, C₁-C₄ alkoxy, —NH—CO—H, —NH—CO—C₁—C⁴-alkyl, —NH₂, —NH—C₁-C₄-alkyl, R¹ and R² are each independently C₁-C₄ alkyl, C₆-C₁₀ aryl or a group which contains a heteroatom, R³ is hydrogen or C₁-C₄ alkyl and n is from 0 to 4, and X is C═O or [C(R′)₂]_{y}— where y is from 0 to 3 and R′ is hydrogen, hydroxyl, C₁-C₄ alkoxy or C₁-C₄ alkyl.

4. The process as claimed in claim 1, wherein the bleach catalyst is a compound of the formula (2)
[MₐLₖXₙ]Yₘ (2)
where M is selected from the group consisting of Mn(II), Mn(III), Mn(IV), Mn(V), Cu(I), Cu(II), Cu(III), Fe(II), Fe(III), Fe(IV), Fe(V), Co(I), Co(II), Co(III), Ti(II), Ti(III), Ti(IV), V(II), V(III), V(IV), V(V), Mo(II), Mo(III), Mo(IV), Mo(V), Mo(VI), W(IV), W(V) and W(VI),
L is a ligand of the formula (1), 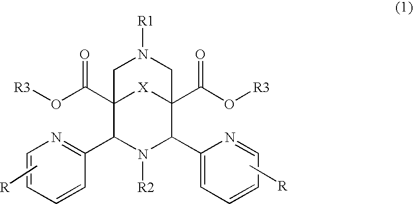
where R¹ and R² are each independently C₁-C₄ alkyl, C₆-C₁₀ aryl or a group which contains a heteroatom,
and R is hydrogen, hydroxyl, C₁-C₄ alkoxy or C₁-C₄alkyl,
X is a singly, doubly or triply charged anion or an uncharged molecule which can coordinate to M,
Y is a noncoordinating counterion,
a is an integer from 1 to 10,
k is an integer from 1 to 10,
n is an integer from 0 to 10, and
m is an integer from 0 to 20.

5. The process as claimed in claim 1, wherein the bleach catalyst is dimethyl 2,4-di(pyridyl)-3-methyl-7-(pyridin-2-ylmethyl)-3,7-diazabicyclo[3.3.1]nonan-9-one-1,5-dicarboxylate or a metal complex of the formula (2)
[MₐLₖXₙ]Yₘ (2)
containing dimethyl 2,4-di(pyridyl)-3-methyl-7-(pyridin-2-ylmethyl)-3,7-diazabicyclo[3.3.1]nonan-9-one-1,5-dicarboxylate as the ligand.

6. The process as claimed in claim 1, wherein the carrier material is sodium sulfate.

7. The process as claimed in claim 1, wherein the acidic polymer is soluble to a degree of more than 5 g/l at 20° C. in water and which, as a 1% solution, has a pH of below 7.

8. The process as claimed in claim 1, wherein the further additive comprises an acidic additive.

9. The process as claimed in claim 1, wherein the process is conducted batchwise wherein a total amount of carrier material is initially charged to the fluidized bed and granulated batchwise with the aqueous solution or suspension comprising bleach catalyst, acidic polymer and any optional further additives.

10. The process as claimed in claim 1, wherein the carrier material and the aqueous solution or suspension comprising bleach catalyst, acidic polymer and optionally the further additives is metered continuously into the fluidized bed apparatus.

11. The process of claim 3 wherein R¹ and R² are each independently of the formula (CH₂)_{z}-2-pyridyl where z is from 1 to 5.

12. The process of claim 4, wherein R is dimethyl 2,4-di(2-pyridyl)-3-methyl-7-(pyridin-1-ylmethyl)-3,7-diazabicyclo[3.3.1]nonan-9-one-1,5-dicarboxylate or the protonated form thereof.

13. The process of claim 4, wherein M is Fe(II), Fe(III), Fe(IV), and Fe(V).
